(19) United States
(12) Patent Application Publication
(10) Pub. No.: US 2016/0197873 A1
(43) Pub. Date: Jul. 7, 2016

(54) METHOD AND APPARATUS FOR VALUING AND OPTIMIZING THE APPLICATION OF SOCIAL CAPITAL IN SOCIAL-MEDIA NETWORKS

(71) Applicant: Ali Saad ALGHAMDI, Carbondale, IL (US)

(72) Inventor: Ali Saad ALGHAMDI, Carbondale, IL (US)

(21) Appl. No.: 14/739,485

(22) Filed: Jun. 15, 2015

Related U.S. Application Data
(60) Provisional application No. 62/099,922, filed on Jan. 5, 2015.

(51) Int. Cl. H04L 12/58

(52) U.S. Cl. CPC H04L 51/32

(57) ABSTRACT

A method and apparatus for determining the social capital of a node in a social network, wherein the social capital is determined by the number of receiving nodes connecting and receiving posts from the node, and the social capital is determined by number of receiving nodes commenting on, sharing, and liking post from the node. The receiving nodes are categorized into “need,” “trust,” admire,” and opposition categories according to the number of “comments,” “shares,” and “likes” of each respective receiving node. The method and apparatus further include optimally allocating resources to influence the behavior of agents corresponding to the receiving nodes, wherein the allocation of resource is optimized using a cost-benefit function valuing the benefit of the node proportional to the calculated social capital of the node.

### CROSS REFERENCE TO RELATED APPLICATIONS

This application relates to and claims priority to U.S. Ser. No. 62/099,922 entitled “An Apparatus to Compute a Social Capital Value” filed Jan. 5, 2015, the entire contents of which are incorporated herein by reference.

### GRANT OF NON-EXCLUSIVE RIGHT

This application was prepared with financial support from the Saudia Arabian Cultural Mission, and in consideration therefore the present inventor has granted the Kingdom of Saudi Arabia a non-exclusive right to practice the present invention.

### BACKGROUND

1. Field

This disclosure relates to an apparatus for calculating and a method of appraising the value of social capital of a social-media node in social-media networks, and more particularly to appraising the value of social capital of a social-media node in social-media networks and using this appraisal of the value of social capital in order to more efficiently use social-media nodes to influence the behavior of agents represented in social-media networks.

2. Description of the Related Art

Social capital is the wealth that an individual or a group possesses in the form of social connectivity and communications, which can be attributed to determinants including need, trust, admiration and opposition. In many instances social capital can operate independent of financial incentives. The determinants affecting social capital are mere phrases to reflect the link between social capital's main sources (i.e., a social capital owner) and the members of that social capital. For example, members in the need category have a common interest and/or shared beliefs with the source node to whom they demonstrate broad support and connection. Opposition members demonstrate broad disagreement with the source node and endeavor to block or otherwise try to diminish social capital of the source node. In the trust category, members provisionally support the source node but will verify the communicative content of the source node before supporting the content. In the admiration category, members receive communications from the source node but are passive with respect to and generally do not act based on the received communications. For example, members in the admiration category remain neutral (e.g., idle), but they are still affirmatively counted toward social capital.

By contrasting traditional social capital models with the modern social capital models in virtual networks, insight can be gained for a richer understanding and greater ability to predict the migration over the virtual social network nodes. Prior to the internet, social capital was established through family kinships. Historically, larger and more influential families mostly controlled their society by leading the community and controlling the markets. The stronger the tribe the more dominant it was among others.

Therefore, people were divided and took sides according the clan to which they belonged. The traditional social capital mostly emanated from the geographical status. In faith communities, for example, the greatest social capital established was under the spiritual doctrines where individuals united under a common dogma and abandoned their family, tribe, city, region, and homeland. This unity was possible in the past, because the individuals in societies were dominated by the individual or the group that had the greatest authority or connectivity among them. In the early 1990's, the internet was introduced to the public, which was a significant element in decreasing the significance of geographical boundaries and overcoming barriers to information access. Today, geography does not limit information and social networks as it once did because distantly located individuals can communicate nearly instantaneously. Information access has multiple pathways and is no longer dominated by the highest authorized individuals or groups.

Nowadays, the criteria of establishing a greater social capital has exceeded the traditional ways and has forced organizations, businesses or any social capital seeker to seek greater understanding of individual beliefs, desires and intentions to be able to gain benefits from prevailing social capital. In other word, individuals have gained greater access to information, and they are no longer limited to their geographical status as they used to be. Therefore, traditional social capital seekers lost their privilege of dominating through traditional information sources.

In business, the capital is the net worth of the business. By analogy, social capital is the net worth that yields its real value or in other word, its real influence on the network. A useful model of social capital will guide decisions about efficient use of social capital to influence actions of network members. So far conventional models of social capital are either non-existent or have been poor at providing guidance for using social capital to affect the actions of agents represented in a social network.

### SUMMARY

According to an exemplary embodiment, a method of valuing social capital in a social network, includes (i) categorizing, according to predefined criteria stored in memory of a processor, a plurality of receiving nodes in communication with a source node originating a post on an internet, wherein each receiving node that connects to the source node is categorized into one of a need category, a trust category, an admire category, and an opposition category; (ii) calculating a total opposition value of the source node using a function including a number of the receiving nodes categorized into the opposition category, a number of the receiving nodes categorized into the need category, a number of the receiving nodes categorized into the trust category, and a number of the receiving nodes categorized into the admire category; (iii) calculating a support value of the source node to include the difference between a number of receiving nodes connected to the source node and the total opposition value of the source node; and (iv) transforming the support value into a social capital value (SCV) by calculating in the processor a ratio of the square of the support value and a weighted sum of the number of receiving nodes respectively categorized into the opposition category, the need category, the trust category, and the admire category.

According to another exemplary embodiment, a social capital value computational apparatus includes an interface connectable to the internet and processing circuitry connected to the interface. The processing circuitry is programmed to categorize, according to predefined criteria stored in memory of a processor, a plurality of receiving nodes in communication with a source node originating a posting on the internet, wherein each receiving node that connects to the source node is categorized into one of a need category, a trust category, an admire category, and an opposition category. The processing circuitry is further programmed to calculate a total opposition value of the source node using a function including a number of the receiving nodes categorized into the opposition category, a number of the receiving nodes categorized into the need category, a number of the receiving nodes categorized into the trust category, and a number of the receiving nodes categorized into the admire category. Additionally, the processing circuitry is programmed to calculate a support value of the source node to include the difference between a number of receiving nodes connected to the source node and the total opposition value of the source node. Moreover, the processing circuitry is programmed to transform the support value into a social capital value (SCV) by calculating in the processor a ratio of the square of the support value and a weighted sum of the number of receiving nodes respectively categorized into the opposition category, the need category, the trust category, and the admire category.

It is to be understood that both the foregoing general description of the invention and the following detailed description are exemplary, but are not restrictive of the invention.

### BRIEF DESCRIPTION OF THE DRAWINGS

A more complete understanding of this disclosure is provided by reference to the following detailed description when considered in connection with the accompanying drawings, wherein:

FIG. 1 shows a plot of the interest (vertical axis) in “social media,” “twitter,” “facebook,” “mobile,” and “youtube” as measured by google searches for these terms as a function of time in years (horizontal axis);

FIG. 2 shows a flow chart of one implementation of a method of calculating a social capital value (SCV) of a source node connected to receiving nodes in a social network;

FIG. 3 show simulation results of social networks having receiving nodes categorized into need, trust, admire, and opposition categories and calculations of the SCV according to the number of member nodes in these respective categories;

FIG. 4 shows a schematic drawing of a hardware implementation of an apparatus for calculating the SCV and for calculating the optimal use of resources in using the calculated SCV of the source node;

FIG. 5 shows a flow chart of one implementation of a method to optimal allocate resources among source nodes of social network by optimizing a cost-benefit function;

FIG. 6 shows a flow chart of one implementation of a method to determine the influence of a source node post and members of the need, trust, admire, and opposition categories;

FIG. 7 shows a drawing of a mapping of the range of an empirically derived influence curve onto the range of the SCV function; and

FIG. 8 shows a flow chart of one implementation of a method to obtain a global minimum of the cost-benefit function.

### DETAILED DESCRIPTION

To derive a useful model providing a valuation of social capital for any node on the network, the discussion herein investigates social-media networks in order to provide an analytical model for computation of the social capital value (SCV) that represents the social capital of a given node of the social-media network. First, the origins of social capital are discussed. Next, salient attributes for the inventive model are outlined. Then, a succinct mathematical model of social capital is provided. After deriving a succinct mathematical model of social capital, a method and computational apparatus of using the mathematical model of social capital to optimally allocate resource, e.g., social-media resources and conventional media resources, for obtaining a predetermined goal is discussed.

The development of ideas and theories about social capital and how they affect complex social networks has been an ongoing process with significant developments since the 1990's. It is clear that social capital ideas exert a major influence in such areas of social science research, political science, economics, and the study of human well-being in areas like sociology and health care. Moreover, there is an increasing understanding regarding the important role of social capital and its influence in society in relationship to modern technologies such as Facebook®, Twitter®, and other social networks.

Researchers are studying the role of social capital in our society and emerging challenges and problems for users of social media to have access to information technologies. Furthermore, researchers are also studying the influence of social capital in our society and its importance. However, researchers have yet to reach consensus regarding many fundamental questions including the fundamental questions of defining “social capital.” For example, divergences in the definition of “social capital” are discussed in D. Castiglione, J. W Deth, and G. Wolleb, The Handbook of Social Capital, Oxford University Press (2008), incorporated herein by reference in its entirety.

Social capital has been increasingly used in many disciplines of social sciences. Social capital has been made the object of numerous studies and has been discussed in thousands of academic papers. This is made clear by the publication of dozens of articles on such issues as how social capital ideas are being used to investigate social capital in democratic ideas, economic development, global cooperation, multi-cultural and ethnic societies, businesses and financing, and social welfare and public policy formation to name just a few. For example, one article in The Handbook of Social Capital discusses how social capital theory has been used by social scientists to explain and understand the role of social capital in affecting collective action by various groups in relationship to improving such things as social and economic development in society. Social capital studies show that investment in physical capital or improving society's roads, bridges and other infra-structure needs is more likely to take place in a society where the people have a strong social capital and have a high level of trust in their existing political and economic institutions. This kind of study using social capital theory shows that improving such things as people's access to information technologies in developing countries might play a major role in helping them better their economic and social situation. Moreover, access to information technologies makes it easier for people to develop more social capital and improve their lives. In another example, social capital ideas help one to understand complex networks that might help improve people's lives.

Social capital is a major element to bolster support of a goal. However, the approaches for accomplishing this goal may differ from one generation to another. Today, social media such as Facebook®, Twitter®, and YouTube® represent the main network gates for harnessing social capital. Thus, these three social-media networks are tools that foster social capital on the large scale.

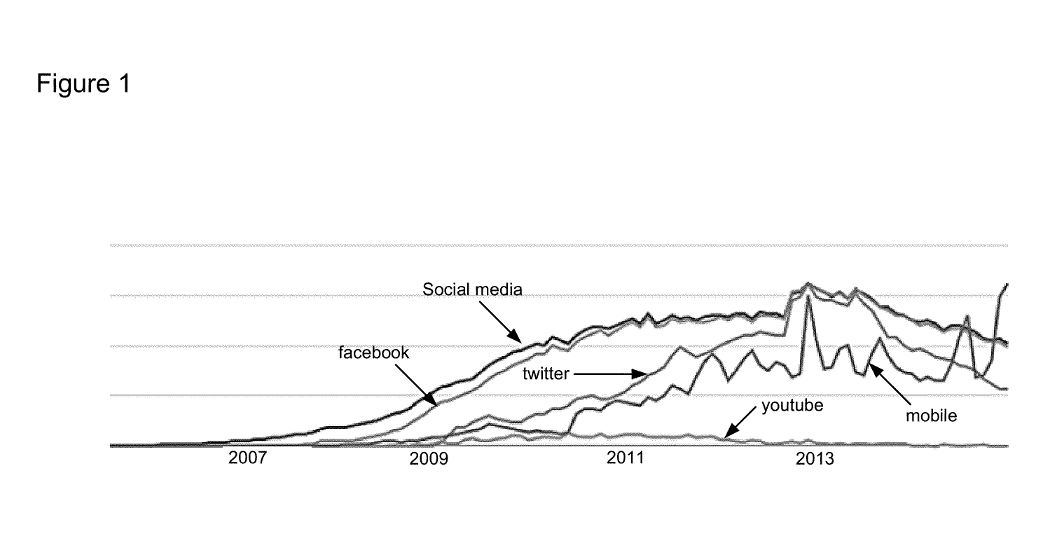

Referring now to the drawings, wherein like reference numerals designate identical or corresponding parts throughout the several views. FIG. 1 shows the number of google searches of the terms “facebook,” twitter,” “youtube,” “social media,” and “mobile” as a function of time. The vertical axis on FIG. 1 reflects how many searches have been done for a particular term, relative to the total number of searches done on Google as a function of time in years (horizontal axis). These respective curves do not represent absolute search volume numbers, because the data is normalized and presented on a scale from 0-100. Each point on the graph is divided by the highest point and multiplied by 100. The interest in a social-media networks Facebook®, Twitter®, and YouTube® is plotted along the vertical axis and time is plotted along the horizontal axis. The worldwide interest in social-media network accelerated near the end of 2006. By 2007, this interest rapidly increased to be a revolution in social media (Facebook®, Twitter®, and YouTube®). One of the influences contributing to this revolution was location invariance of “web connectivity” through smartphones. This combination of mobility of web connectivity and social-media environment created instant event reactions. For example, an individual owning a smartphone and an account on any of the social-media platforms can report an event even before news organizations know about the event.

Table 1 shows the number of active users in the social-media platforms. As shown in Table 1, Facebook® and YouTube® have more than a billion monthly active users and Twitter® has two hundred thirty million active users every day. The amount of social capital for any member of social-media platforms can be traced to the members' interactions creating the social capital. The members' interactions can be categorized into classes of interactions that are enabled by the social-media platform among members. These classes or categories of interactions can be assigned values commensurate with their effect on other members.

TABLE 1
Active users on social-media platforms.
Active users for social-media platforms.

| Social platform | Active users |
|---|---|
| Facebook ® | One billion + monthly |
| Twitter ® | 230 million daily |
| YouTube ® | One billion + Monthly |

In a network, an agent is a catalyst between intention and action. There are two major groups of agents among the social network. The first one, systematic agents, is a set of algorithms that is predictable by the system and used by the social platform. The second one, human agents, is represented by the human interaction on the network which is not predictable. Human agents among the network are divided into two sub-groups. The first group is those who use the network in professional matter such as, commercial advertisers, social crusaders who are fighting/defending a cause, news disseminators, etc. The other group is those who are using the network for entertainment. The first group is an aware agent and the second is unaware. It can be assumed that everyone using the network is an agent, and further it can be assumed that an agent can become/remain active at any time. This activation is not systematic and can happen at any time depending on network internal or external motivation toward a cause. This cause can be anything either personal or general and it is not limited to specific interest. Thus, social capital on the network is a group of agents who are motivated by a personal cause toward a general cause.

In a social network, these causes are in the form of information, and the social capital will be built according to the interest of the network agents in that information. Therefore, to control the access to information means controlling the growth of social capital. For example, the growth of social capital can be viewed as a race between attackers and defenders. The attackers who support the cause will try to access more information to support their cause, and the defenders will try to block or construe the information to eliminate the cause. As a result, social capital on the network becomes a major factor in steering events. Based on the previous observations, social capital on the social network is generated by providing information.

On any network node, the value of information provided to the network's human agents is determined by the connectivity of those agents to that node. On the other hand, the link's value of the network human agent to that node varies because it depends on human behavior. Human agents can only interact with the network through systematic agents. Thus, categorizing the systematic agents on social networks also results in categorizing the human agents' linked to a node on a given social network. The social capital value of a node on the network will depend on the values of those links toward it. Consequently, the number of the links to a node does not represent its social capital value, but it represents only the number of connected links. Thus, a measure of social capital value (SCV) should be based on more than the number of links—it should also represent the nature and quality of those respective links.

The SCV depends on the characterization of the social-network human agent's interactions. This methodology of determining the SCV for a certain node depends on the value that a link will give when it supports or opposes that node. The supporting links connected to a node can exhibit one of unconditional support (need), conditional support (trust), and neutral support (admire). The opposition links represent opposition that will disturb the reputation of the node so its social capital would be lessened.

Similarly, organizations have four types of inter-related social networks: customer, supplier, competitor, and partner. This classification describes the relation between members of social network without considering the centrality of network in order to find the social capital. In other words, the social capital in such classification is distributed over the network members. Therefore, in order to find the social capital of a node in the social network (called the source node), the relation between all connected nodes (e.g., receiving nodes) and the source node should be identified.

Each node on the network has its own social capital. The node's social capital value (SCV) depends on the support/opposition the node receives via its links with other nodes. The values of the links depend on how much support a node gives toward the source node. Therefore, the links are categorized according to their support toward the source node to which they are connected. The four categories considered here are three categories of support nodes (i.e., need nodes, trust nodes, and admire nodes) and one category of opposition node (i.e., opposition nodes). Regarding need nodes in social network, support can be expressed the most by connected distributive nodes that help the main nodes to spread its influence among the network. Regarding trust nodes in social network, the trust nodes are next support nodes that are those who are partially distributive. The last support comes from admire nodes that are connected to the main node as receivers but do not act to further distribute the communicative content from the source node. On the other hand, every social capital has opposition which tries to attenuate the social capital influence of the source node. The different member categories of the social capital members are in descending order of support:

1. Need members: (unconditional support) are those who distribute the contents without questioning. (e.g., common interests, mores, beliefs, devotion, and/or trust).

2. Trust members: (conditional support) are those who distribute the contents based on their norms.

3. Admiration members: (neutral support) are those who have no interaction within the social capital. Based on “Just to know what is going on.”

4. Opposition members: (opposing links) are those members who try to block the distribution by contempt of the main node's contents.

In analyzing social capital, the SCV model calculates the amount of support that a node receives from all connected nodes (i.e., receiving nodes). In one SCV model of the invention: V is the total number of connections/links between the source node and receiving nodes (i.e., member nodes belonging to either support or opposition categories), N is the total number of members belonging to the need category, T is the total number of members belonging to the trust category, A is the total number of members belonging to the admiration category, OP is the total number belonging to the opposition category, and OPI is the total amount of opposition. The maximum amount of support that a node can have is when all connected nodes are from the category of need (N) which at this case SCV will equal V/c₃. The normalized values of need, trust, and adore nodes are respectively given by dividing the number of nodes in each category the total number of connected nodes V:

$$α = \frac{N}{V} , \\ β = \frac{T}{V} , and$$

$$Ω = \frac{A}{V} .$$

The total amount of opposition is given by OPI, which is expressed as

$$OPI = OP + OP \sqrt{{( \frac{α}{{w}_{3}} )}^{2} + {( \frac{β}{{w}_{2}} )}^{2} + {( \frac{Ω}{{w}_{1}} )}^{2}} ,$$

wherein the total opposition includes both the number of opposition members OP and the effect of the opposition members eroding the support by the need, trust, and adore members, with the weight coefficients w₁, w₂, and w₃ expressing the amount of support eroded by the effects of opposition members on support members. The support of the social capital members is then given by

S=V−OPI.

Finally, in one implementation, the value of SCV is given by

$$SCV = \{ \begin{matrix}\frac{{S}^{2}}{{c}_{3} N + {c}_{2} T + {c}_{1} A + {c}_{4} OP} & OPI < N + T + A \\ \frac{- {S}^{2}}{{c}_{3} N + {c}_{2} T + {c}_{1} A + {c}_{4} OP} & OPI \geq N + T + A\end{matrix} .$$

Where c₁, c₂, c₃, and c₄ are coefficients that can be adjusted to fit the SCV model to empirical data. In one implementation, these coefficients are constrained according to 1≦c₁<c₂<c₃ and 1≦c₄. Further, in one implementation, when OPI is greater than the sum of the support categories, then the SCV is positive. Otherwise, the SCV is negative.

In an alternative implementation, SCV is calculated according to

$$SCV = \frac{S \vert S \vert}{{c}_{3} N + {c}_{2} T + {c}_{1} A + {c}_{4} OP} ,$$

wherein |S| is the absolute value of the pure support function S.

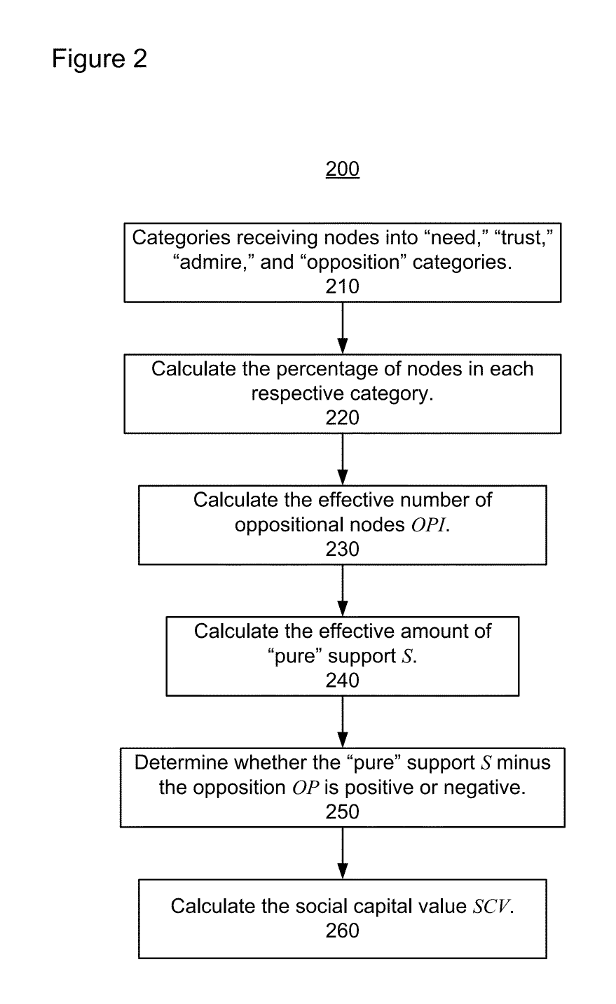

FIG. 2 show a method 200 of calculating the social capital value (SCV) for a source node connected to a plurality of receiving nodes. The first step of method 200, i.e., step 210, determine categories for the receiving nodes connected to the source node according to the categories “need,” trust, “admire,” and “opposition.” The method employed to determine the categories for these nodes is discussed later. Next, at step 220 for method 200, the normalized number of nodes occupying each category is calculated according to

$$α = \frac{N}{V} , \\ β = \frac{T}{V} , and$$

$$Ω = \frac{A}{V} .$$

Next, at step 230 for method 200, the total amount of opposition, including the effect of the opposition nodes on support nodes, is calculated as

$$OPI = OP + OP \sqrt{{( \frac{α}{{w}_{3}} )}^{2} + {( \frac{β}{{w}_{2}} )}^{2} + {( \frac{Ω}{{w}_{1}} )}^{2}} .$$

Next, at step 240 for method 200, the value of the pure support is calculated by subtracting the total number of nodes the total opposition, as indicated by the expression

S=V−OPI.

Next, at step 250 for method 200, the inequality between the support nodes and the total opposition is evaluated to determine whether the social capital value SCV is positive or negative. Finally, at step 260 for method 200, the social capital value SCV is calculated according to the expression

$$SCV = \{ \begin{matrix}\frac{{S}^{2}}{{c}_{3} N + {c}_{2} T + {c}_{1} A + {c}_{4} OP} & OPI < N + T + A \\ \frac{- {S}^{2}}{{c}_{3} N + {c}_{2} T + {c}_{1} A + {c}_{4} OP} & OPI \geq N + T + A\end{matrix} .$$

Also, in an alternative implementation SCV can be calculated according to

$$SCV = \frac{S \vert S \vert}{{c}_{3} N + {c}_{2} T + {c}_{1} A + {c}_{4} OP} .$$

In analyzing social capital, the SCV calculation accounts for the amount of support that a source node receives from all connecting nodes, wherein the support from each connected receiving node is apportioned according to the receiving node's category and opposition nodes contribute negatively and erode the support of the support nodes. In one implementation, the maximum amount of support that a node can have is when all connected nodes are from the need category, in which case SCV will equal V/c₃. The value OPI represents the total amount of opposition where the influence of the opposition on the other categories is considered by using the other categories ratios to the volume of the social capital. The pure support of the social capital members can be found by finding the value of S. In one implementation, the value of SCV is conditioned by the ratio of the OPI to the total amount of the other categories. When the ratio of OPI to the other categories is less than one then the SCV is positive; and when it is greater than one, SCV will be negative.

TABLE 2
Code terms guide.

| Code expression | Meaning |
|---|---|
| V | Volume of the social capital |
| N(i) | Need value at i cycle |
| T(i) | Trust value at i cycle |
| A(i) | Admire value at i cycle |
| OP(i) | Opposition value at i cycle |
| OPI(i) | Opposition influence value at i cycle |
| Alpha(i) | Need to volume ratio |
| Beta | Trust to volume ratio |
| omega | Admire to volume ratio |
| SCV | Social capital value |

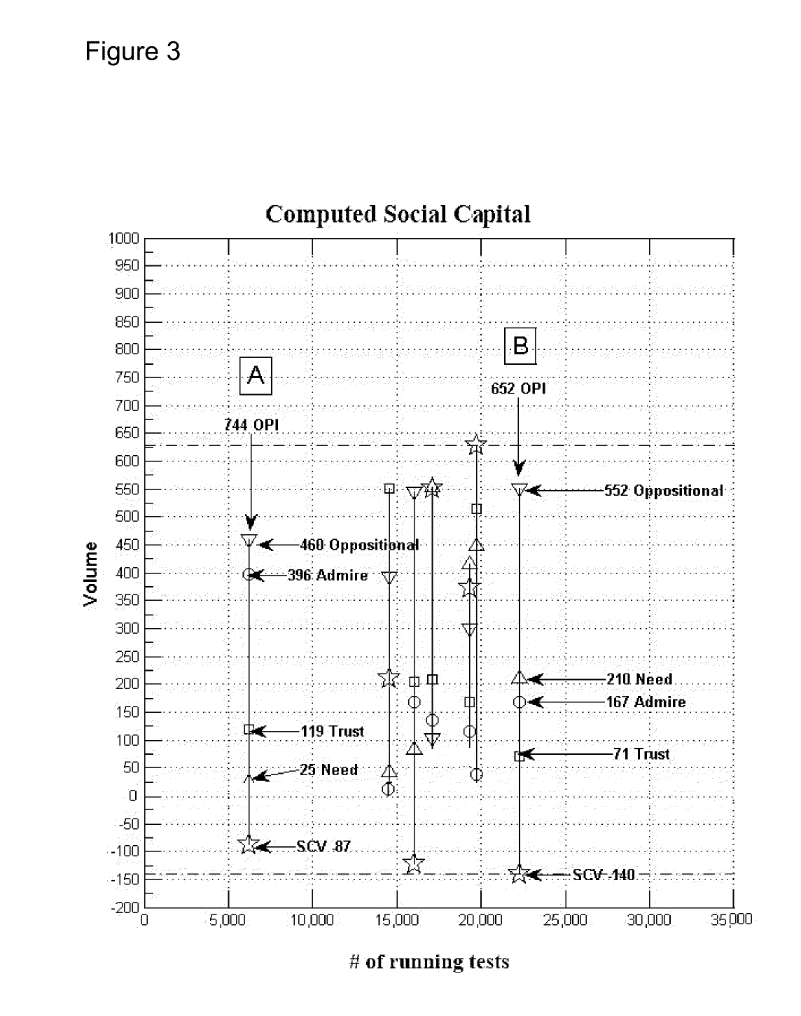

FIG. 3 shows results from seven simulations of source nodes having 1000 connections. In these simulations the number of nodes in each category was calculated using a random number generator. Two of these simulations have been labeled “A” and “B” respectively for purposes of discussion. In the simulations, the volume of members has been chosen to be 1000. Each iterative loop of the simulation generates random values for N, T, A and OP. When the summation of the generated values equal to the volume, it calculates SCV, otherwise, it generates values again. In FIG. 3, the star shape indicates the total SCV. In FIG. 3, the upright triangle shape indicates the number of nodes in the need category, and the upside-down triangle shape indicates the number of nodes in the opposition category. In FIG. 3, the square shape indicates the number of nodes in the trust category, and the circle shape indicates the number of nodes in the admire category. Table 2 shows the meaning of the code expressions used to build up the Matlab® code used for this simulation. In the simulation, the coefficient vector C=[c₁,c₂,c₃,c₄,w₁,w₂,w₃] has been set to C=[3,2,1,0,1,2,3].

The matlab code of the simulation is given by:

1. clear;
2. clc;
3. V=1000;
4. for i=1:100000
5. N(i)=randi([0 V]);
6. T(i)=randi([0 V]);
7. A(i)=randi([0 V]);
8. OP(i)=randi([0 V]);
9. sum(i)=N(i)+T(i)+A(i)+OP(i);
10. if sum(i) == V
11. need(i)=N(i);
12. trust(i)=T(i);
13. admire(i)=A(i);
14. Opposition (i)=OP(i);
15. alpha(i) = N(i)/V;
16. beta(i) = T(i)/V;
17. omega(i) = A(i)/V;
18. OPI(i)= OP(i)+OP(i)*sqrt((((alpha(i)/3)\hat{ }2)+((beta(i)/2)\hat{ }2)+
((omega(i)/1)\hat{ }2)));
19. S=(V−OPI(i));
20. if OPI(i)<N(i)+T(i)+A(i)
21. SCV(i) = S\hat{ }2/((N(i)*1)+(T(i)*2)+(A(i)*3));
22. else
23. SCV(i) =−S\hat{ }2/((N(i)*1)+(T(i)*2)+(A(i)*3));
24. end
25. end
26. end.

FIG. 3 shows seven results (i.e., instantiations of the simulation) from the simulations of the value of SCV. Each simulation of SCV obtains different values of N, T, A, and OP. In the simulations, the value of SCV is a maximum value when most of the members are from the need category and is a minimum value when most of the members are opposition members. The negative values of SCV indicate that the influence of opposition members on the social capital exceed the support from other categories of the social capital. For example, FIG. 3 shows A and B illustrating simulations results having negative values for SCV.

Interestingly, the opposition influence in simulation “A” is higher than the opposition influence in simulation “B” even though simulation “B” has more opposition members. The reason for this somewhat unexpected result is that simulation “A” has a higher number of admire members and a lower number of need members than simulation “B.” In simulation “B” the number of need category members is the greater than the other supportive categories. This example illustrates that the opposition in simulation “A” has effectively gained 284 members out of the supportive members to be 744 whereas without swaying any support members to the opposition's side the number of opposition members is only 460. In contrast, the opposition in simulation “B”, which includes 552 members, could influence only 100 members out of the supportive categories and to reach an effective 652 members in the opposition category.

Before calculating the SCV, the SCV model first categorizes receiving nodes into the various categories of connections. Thus, the SCV model includes definitions of what empirical factors differentiate need members from trust, admire, and opposition members. Further, the SCV model includes definitions of what empirical factors differentiates an opposition member from need, trust, and admire members, and so forth. The most applicable environment for tracking the social capital on the network is the social-media platforms where the human interactions toward any node on the network can be recorded. Most of the social-media platforms have three major systematic algorithm agents where most of the interactions go through. These agents are called “share,” “comment,” and “like,” and users of social networks such as Facebook® will be familiar with these modes of social network interaction. Using the combinations of these three agents, member categories can be identified based on the number and percentage of shares, comments, and likes a receiving node exhibits in response to a post by the source node. Based on the how much support that the receiving nodes exhibit towards source node, the receiving nodes can be categorized into one of the member categories.

The types of network interaction (share, comment, and like) define a three dimensional space with the three axes corresponding respectively to one of share, comment, and like; and this three dimensional space can be partitioned into four volumes, with each volume corresponding to one of the categories: need, trust, admire, and opposition. Between a given source node and a receiving node, an average interaction can be calculated by averaging over all of the responses (i.e., the likes, shares, and comments) to the source node. This average interaction determines the agents point in the three dimensional social network space, and the node category corresponding to the agent is determined by the partitioned volume in which the agent's average interaction falls. Table 3 shows one implementation of the social capital categories and a definition characterizing their average responses to the source node.

TABLE 3
Social capital categories interactions.

| Category | Interaction |
|---|---|
| Need | Unconditional Share only |
| Trust | Conditional Share & Comment |
| | or Like |
| Admire | Most action is like only |
| Opposition | Comment only |

In one implementation, the partitioning of the three dimensional social network space into categories is determined by several guiding principles. It is assumed that the social capital growth is the highest priority sought by the source node. The distributive nodes (i.e., receiving nodes expressing a willingness to redistribute posts received from the source node) on the network are the most supportive and therefore provide the greatest social capital. Therefore, members of the social capital who are sharing unconditionally are considered as distributive members and receiving nodes are categorized according to how distributive each receiving node is. For example, need members generate the highest social capital because they tend to unconditionally distribute posts from the source node. On the other hand, the non-distributive members weaken the social capital. Admire and opposition categories are not distributive members. However, the opposition members do not only limit distribution by failing to share or like the source node message; they can also comment disparagingly on the source node message degrading the social capital of the source node.

In one implementation, the actions of trust members can be dictated by individual norms of the respective trust members. Therefore, trust members will distribute the message of the source node if the message aligns with the trust members' norms, but trust members first confirm that the message aligns with their norms before either commenting on or liking the message of the source node.

In one implementation, the demarcation between need, trust, admire, and opposition member is achieved by defining a combination of thresholds. These thresholds partition up the three-dimensional like-comment-share space such that those receiving node within the need partition are need members, those receiving node within the trust partition are trust members and so forth. Thus, each point in the social network space (i.e., the three-dimensional like-comment-share space) will demarked by the threshold boundaries into one of four partitions or regions, wherein each partition/region can be defined by a combination of more than one threshold boundaries, and each threshold can be defined as an inequality expressed in terms of a mathematical expression wherein the variables within the mathematical expression can be the number/ratio of likes, shares, and comments.

For example, in one implementation, need members connecting to a source node of a social network can be defined as those receiving nodes that are connected to the source network and that share a percentage of the source node's posts exceeding a first predetermined “share” threshold, i.e.,

x=need if Pₓ(Share)>Tᵢ^{(Share)},

where x is a post received from the source node by the receiving node, Pₓ (Share) is the probability of sharing the post x, and T₁^{(Share)} is the first “share” threshold.

Trust members connecting to the same source node are defined as those receiving nodes having a sharing probability less than the first “share” threshold, but not less than a second “share” threshold T₂^{(Share)}, where T₂^{(Share)}<T₁^{(Share)}. Also, the trust members either share and/or comment on a predetermined percentage of posts by the source node, i.e.,

M=trust if T₁^{(Share)}≧Pₓ(Share)>T₂^{(Share)} and

Pₓ(Com)+k₁Pₓ(Like)+k₂pₓ(Like∩Com)>T₁^{(Com,Like)},

where M is the member category of the receiving node, T₁^{(Com,Like)} is the first “like/comment” threshold, Pₓ (Like) is the probability of the receiving node liking the post x, k₁ is a predetermined number, Pₓ(Com) is the probability of the receiving node liking the post x, Pₓ(Like∩Com) is the probability of the receiving node both liking and commenting on the post x, and k₂ is a predetermined number. In one implementation k₁=1 and k₂=−1 such that

M=trust if T₁^{(Share)}≧Pₓ(Share)>T₂^{(Share)} and Pₓ(Like∪Com)>T₁^{(Com,Like)},

where Pₓ(Like∪Com) is the probability that the post x belongs to the union of posts that the receiving node likes and the posts that the receiving node comments on.

Opposition members connecting to the source node can be defined as those receiving nodes having a probability of sharing that is less than the second “share” threshold, liking less than a first like threshold T₁^{(Like)}, commenting on greater than a first comment threshold T₁^{(Com)}, and not being members of either the need or trust categories.

M=opposition if Pₓ(Share)≦T₂^{(Share)} and Pₓ(Like)<T₁^{(Like)}

and Pₓ(Com)<T₁^{(Com)} and M≠trust and M≠need.

Finally, admire member can be defined as those receiving nodes that are not categorized as need, trust, or opposition members. One of ordinary skill in the art will recognize that many other combinations of thresholds can be defined to demark the boundaries between the need, trust, admire, and opposition categories. The partitions discussed herein are illustrative and not limiting.

An advantage of the SCV calculation over other methodologies of calculating social capital is that SCV calculates the amount of social capital supporting a cause sponsored by the owner of that social capital. For these sponsored activities of the social capital owner, the SCV provides a value indicative of the social capital received by the source node as support from the receiving nodes. For example, consider two nodes on the network, node “C” and node “D”. If it is assumed that both are active nodes and they have different numbers of connected nodes. Node “C” has 2000 connected nodes and node “D” has 1000 connected nodes. In a conventional methodology for calculating social capital that considers only the number of connecting nodes, node “D” will be considered having 2000 of social capital for node “C,” and 1000 social capital for node “D.” However, the effect of nodes “C” and “D” may differ from their respective number of connection, thus limiting the predictive capacity of the conventional methodology for calculating social capital that considers only the number of connecting nodes. In contrast, in the SCV methodology every receiving node of the social capital has have a value determined by the receiving node's activities within the social capital network.

When the SCV is calculated using the inventive model, the SCV provides a number that is equal or less than the total number of connected nodes (i.e., 1≦c₁<c₂<c₃). For example, assuming that the coefficient vector C=[c₁,c₂,c₃,c₄,w₁,w₂,w₃] is given by C=[3,2,1,0,1,2,3], node “D” can have social capital more than for node “C”, while it has only 1000 nodes and for node “C” has 2000 nodes. The number of nodes of each category in the social capital will determine which node, node “C” or node “D,” has more social capital. For example, if node “C” has 1000 members of need category, 150 of trust category, 350 of admire category and has opposition of 500 members. Node “D” has 950 of need category and 50 of trust category and has no admire and no opposition members, then Table 4 summarizes the SCV calculation for node “C” and node “D.” From these result, one can observe that the SCV of node “C” is approximately 808 members, and the SCV of node “D” is approximately 952 members. Further, one can observer that node “D” has more social capital than node “C,” whereas node “C” has more connections than node “D”.

TABLE 4
A calculation of the SCV for nodes “C” and “D.”

| | “C” | “D” |
|---|---|---|
| N | 1,000 | 950 |
| T | 150 | 50 |
| A | 350 | — |
| OP | 500 | — |
| V | 2,000 | 1,000 |
| α | 0.500 | 0.950 |
| β | 0.075 | 0.050 |
| Ω | 0.175 | — |
| OPI | 622.3 | — |
| N + T + A | 1,500 | 1,000 |
| SCV | 807.7 | 952.4 |

Thus, the social capital in the social network can be represented by the amount of support not the number of connections. In comparison to conventional notions of capital, which represent the net worth of a business, social capital represents the net support of the total connections of a node of a social network. Social connections in the social network can be categorized into support, partially support, neutral, and non-support categories corresponding respectively to need nodes, trust nodes, admire nodes, and opposition node. While the SCV is not the only formulation to appraise the value of social capital, the SCV has an advantage that it represents the real measurement for the social influence and it is a way to standardize the measurement of social capital. Further, social capital depends on human behavior which is unpredictable, but it is traceable. Therefore, the value of the social capital will change over time depending on new events and disturbances changing the dynamics of the network interactions. Thus, tracking the changes of SCV over time and correlating these changes with related information about changing real-world events, effects, and interactions potential creates the ability to predict future changes in SCV and use the SCV to predict changes and effects of the social network on real-world behaviors.

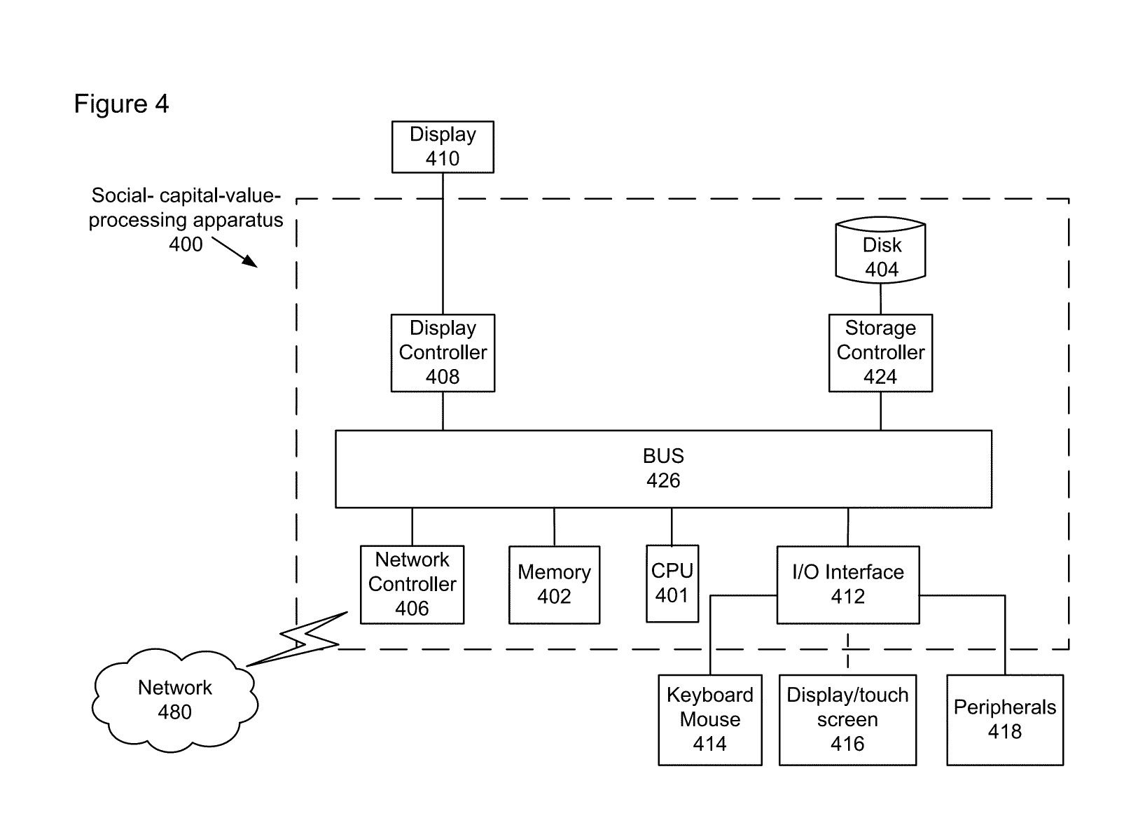

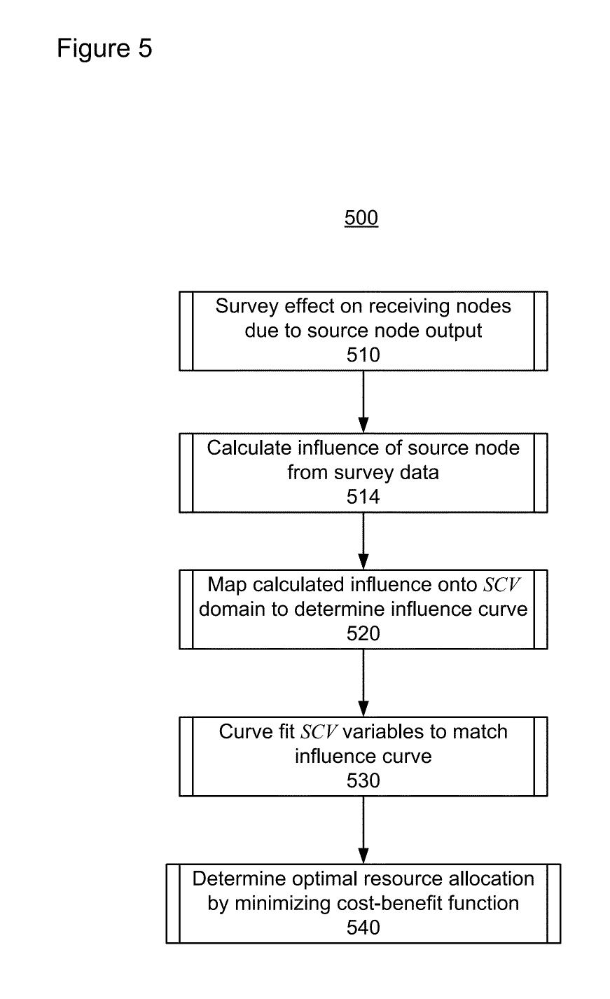

Next, a hardware description of the social-capital-value-processing apparatus 400 is presented for performing the method 200 and the method 500 and the processes therein. The hardware description of the social-capital-value-processing apparatus 400 is presented according to exemplary embodiments is described with reference to FIG. 4. In FIG. 4, the social-capital-value-processing apparatus 400 includes a CPU 400 which performs the processes described above and below including method 200 and method 500 and the processes therein. The process data and instructions may be stored in memory 402 for example as programmed algorithms where the steps in FIG. 2 (or FIG. 5) are encoded so that, when executed, a special purpose processor accomplishes the functions described above (or below) in part or in whole. These processes and instructions may also be stored on a storage medium disk 404 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the Social-capital-value-processing apparatus 400 communicates, such as a server or computer.

Further, the claimed advancements may be provided as a utility application, background daemon, or component of an operating system, or combination thereof, executing in conjunction with CPU 400 and an operating system such as Microsoft Windows 7, UNIX, Solaris, LINUX, Apple MAC-OS and other systems known to those skilled in the art.

CPU 400 may be a Xenon or Core processor from Intel of America or an Opteron processor from AMD of America, or may be other processor types that would be recognized by one of ordinary skill in the art. Alternatively, the CPU 400 may be implemented on an FPGA, ASIC, PLD or using discrete logic circuits, as one of ordinary skill in the art would recognize. Further, CPU 400 may be implemented as multiple processors cooperatively working in parallel to perform the instructions of the inventive processes described above. Further, the CPU 400 can be implemented using cloud computing, remote processing resources, or distributed computing among multiple independent networked processors.

The social-capital-value-processing apparatus 400 in FIG. 4 also includes a network controller 406, such as an Intel Ethernet PRO network interface card from Intel Corporation of America, for interfacing with network 480. As can be appreciated, the network 480 can be a public network, such as the Internet, or a private network such as an LAN or WAN network, or any combination thereof and can also include PSTN or ISDN sub-networks. The network 480 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The social-capital-value-processing apparatus 400 further includes a display controller 408, such as a NVIDIA GeForce GTX or Quadro graphics adaptor from NVIDIA Corporation of America for interfacing with display 410, such as a Hewlett Packard HPL2445w LCD monitor. A general purpose I/O interface 412 interfaces with a keyboard and/or mouse 414. The general purpose I/O interface also connect to a variety of peripherals including printers and scanners, such as an OfficeJet or DeskJet from Hewlett Packard.

The general purpose storage controller 424 connects the storage medium disk 404 with communication bus 426, which may be an ISA, EISA, VESA, PCI, or similar, for interconnecting all of the components of the Social-capital-value-processing apparatus 400. A description of the general features and functionality of the display 410, keyboard and/or mouse 414, as well as the display controller 408, storage controller 424, network controller 406, and general purpose I/O interface 412 is omitted herein for brevity as these features are known.

FIG. 5 shows a method of 500 of choosing the values of the coefficient vector C=[c₁,c₂,c₃,c₄,w₁,w₂,w₃] to correspond with a given social-media message and desired response. After determining the values of the coefficient vector, the optimal allocation of resources including social-media resources can be determined using a cost-benefit function that balances the costs and benefits of deploying resources along traditional media (e.g., television and radio advertisements), social media, and other types of campaigns directed at influencing behavior of the agents represented at the social network nodes.

Method 500 begins at process 510 by surveying receiving nodes regarding the effect of a post by a source node. The receiving nodes are categorized according to the categories need, trust, admire, and opposition. In one implementation, the survey asks a series of question regarding the receiving nodes opinions and behavior surrounding the subject matter of the source node's post. The opinions and behavior of the receiving node can be inquired of both before and after the post to determine the original orientation of receiving node to the subject matter of the post and the changing behavior of the receiving node after the post. From this survey, the influence of the post can be determined.

TABLE 5
Answer choices in a survey.

| select | Opinion/behavior | influence |
|---|---|---|
| a) | Absolute agreement | p₁ |
| b) | strongly agree | p₂ |
| c) | agree | p₃ |
| d) | some what agree | p₄ |
| e) | indiferent | p₅ |
| f) | some what disagree | p₆ |
| g) | disagree | p₇ |
| h) | strongly disagree | p₈ |
| i) | Absolute disagreement | p₉ |
| j) | NA | p₁₀ |

For example, in the survey, a receiving node could be asked whether they agreed with a certain opinion and then directed to select the most appropriate row from Table 5. Given the choice from Table 5 an influence value pᵢ is assigned relating the expressed opinion to the desirability of the behavior correlating with the expressed opinion. In one implementation, the surveyed node is asked to choose a number between zero and ten with ten showing the strongest agreement and zero showing the most disagreement. In one implementation, the surveyed nodes are observed for their behavior rather than answering a questionnaire. For example, the buying habits of a receiving node/agent can be observed before and after a post by a source node, and the effect of the source node can be determined based on the changes of buying habits of the receiving node/agent. In one implementation, only the behaviors and opinions of the receiving node after the post are observed. In one implementation, both questionnaires and behavioral observations are used to determine the effect/influence of the post on the receiving node. The post by the source node and the behavior/opinions surveyed are chosen to closely model the post and behavior/opinions to be considered in the optimization process using a cost-benefit function.

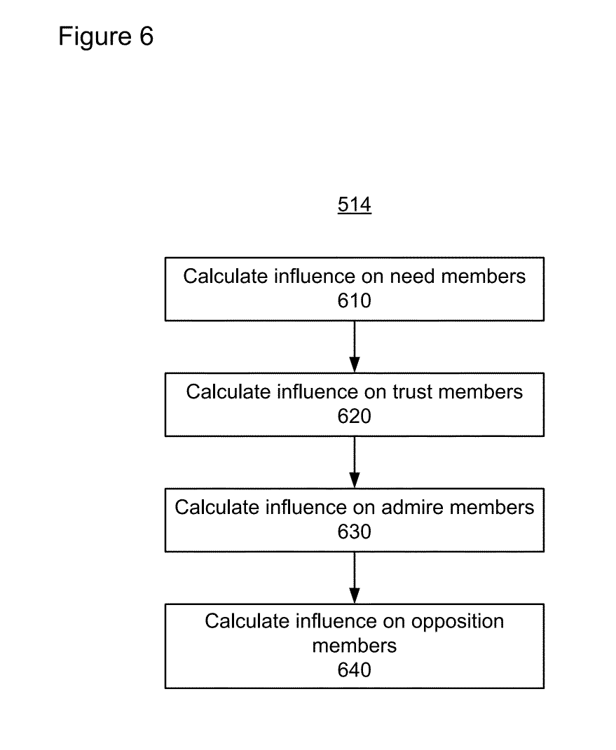

After surveying many nodes of each member category in step 510, process 514 of method 500 calculates the average influence/effect of the post of the source node on each of the respective categories of nodes. FIG. 6 shows for one implementation of process 514 the steps of calculating the average influence on the respective members. In step 610 the statistical variables of the influence of the post on the need members is calculated, including the mean and variance of the influence. Statistical calculations can be performed using any known method, including bootstrapping and jackknifing methods. In step 620 the statistical variables of the influence of the post on the trust members is calculated. In step 630 the statistical variables of the influence of the post on the admire members is calculated. In step 640 the statistical variables of the influence of the post on the opposition members is calculated. Additional, subsets can be randomly sampled from the surveyed nodes in order to calculate multiple average influence values and variances corresponding to random subsets having different distributions of need, trust, admire, and opposition members. These average values define a surface in the four dimensional space defined by the percentage of need, trust, and admire members and the average influence. The percentage of opposition members can be determined from the percentage of need, trust, and admire members because the percentage of all members must total to 100 percent. Here, “influence” means the degree to which a desirable outcome was achieved. The definition of desirable outcome is fact dependent on a particular situation and goal. In the context of commerce, a desirable outcome could be realizing a commercial transaction (e.g., the agent of a receiving node buys a particular product). In a political context, a desirable outcome could be the agent of a receiving node voting for a particular person or cause. A desirable outcome could be the agent of a receiving node viewing a website, or agreeing with a moral axiom or propaganda (e.g., the slogan “just say no” or “stop cyber bullying”). The influence surface/curve can be defined as

E(I[α,β,Ω]),

where E ( ) signifies the expectation value and I[ ] is the influence calculated from the survey data.

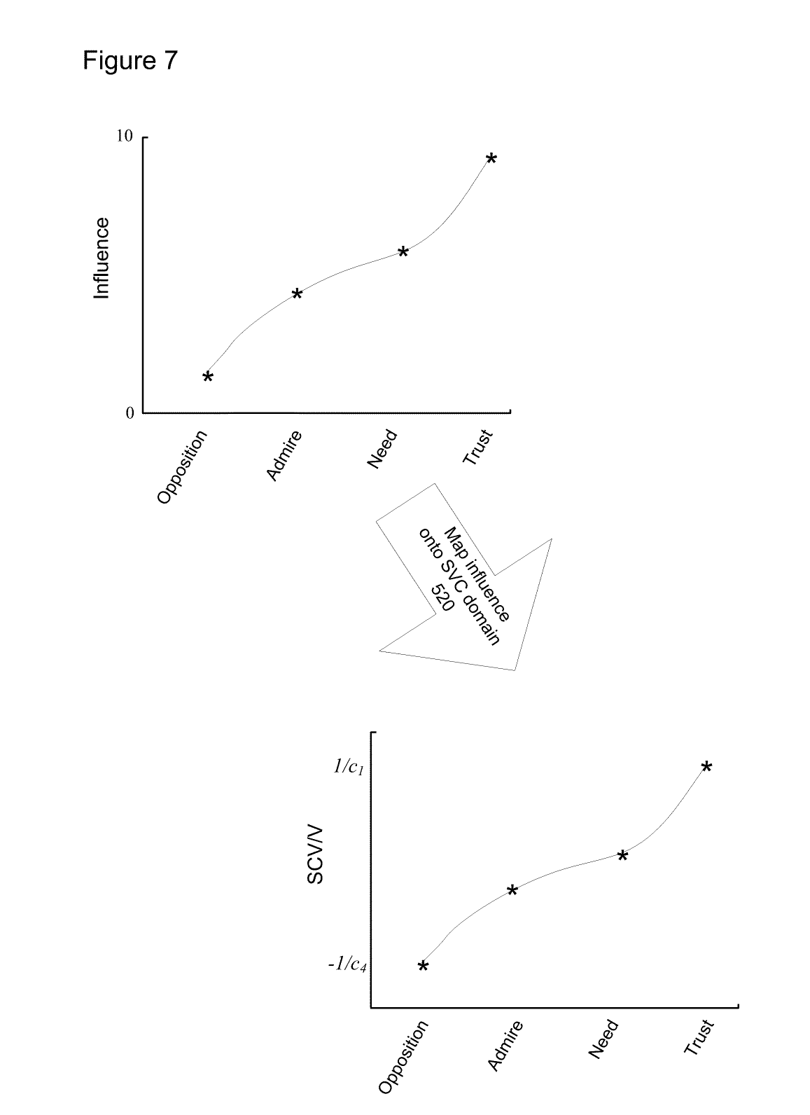

Next in process 520 of method 500, the influence curve corresponding to average influence for each of the need, trust, admire, and opposition categories is mapped onto the SCV domain as shown in FIG. 7. In one implementation, this mapping can be simple resealing the values used to represent the influence (e.g., where the influence is shown on a scale ranging from zero to ten) to the values used to represent the SCV (e.g., the SCV can have a minimum of −1/c₄ and a maximum of 1/c₃ as shown in FIG. 7). Thus the influence surface is resealed to be

SVC⁽¹⁾=M(α,β,Ω)E(I[α,β,Ω])+OS,

wherein M(α,β,Ω) is a mapping function and OS is an offset. In some implementation the mapping function M(α,β,Ω) is a constant defining scaling factor to relate the slope of the influence curve to the slope of the SCV curve.

Next, in process 530 of method 500, the values in the coefficient vector C=[c₁,c₂,c₃,c₄,w₁,w₂,w₃] are adjusted to minimize a predetermined distance measure between SCV⁽¹⁾ and SCV. This process of adjusting the coefficient vector to minimize the distance measure can also be referred to as fitting the SCV curve to the scaled influence curve. In one implementation, the distance measure can be the root mean square, which is given by

$$D ( {SCV}^{( I )} , SCV ) = \sqrt{\frac{1}{N} {\sum }_{i}^{N} {( {SCV}_{i}^{( I )} , {SCV}_{i} )}^{2}} ,$$

where the subscript i corresponds to values of SCV⁽¹⁾ and SCV corresponding to the node percentages αᵢ, βᵢ, and Ωᵢ. In another implementation, a maximum likelihood distance measure can be used as the distance measure. One of skill in the art will recognize that any distance measure between the two vectors corresponding to SCV⁽¹⁾ and SCV can be used for tuning the parameters C=[c₁,c₂,c₃,c₄,w₁,w₂,w₃] to optimize the match between the SCV curve and the scaled influence curve.

After determining the values of the coefficient vector C=[c₁,c₂,c₃,c₄,w₁,w₂,w₃], method 500 proceeds to step 540. In step 540, the SCV is used to calculate the value of a cost-benefit function. The cost-benefit function weighs the trade-offs between the cost of allocating resources towards a social-media campaign against the benefits created from the effects of the social-media campaign on peoples actions. When the marginal costs of allocating more resources are outweighed by the marginal benefit, the cost-benefit function will decrease, and the cost-benefit function increases when the opposite is true. Because the cost-benefit function may have more than one local minimum, a global optimization method is used to find the global minimum. In another implementation where there is little risk of solving for a suboptimal local minimum, a local minimization method can be used.

The benefit of the social-media campaign is given by the aggregate of the SCV for each of the source nodes available to participate in the social-media campaign. The resource cost of each source node can be scaled to use the same scale as the SCV. In one implementation, the cost-benefit function can be expressed as

$$φ ( R = {r}_{1} , {r}_{2} , … {r}_{i} ) = Cost ( {r}_{1} , {r}_{2} , … {r}_{i} ) - {\sum }_{i}^{N} {K}_{i} ( {r}_{i} ) {SCV}_{i} + {\sum }_{i \neq j}^{N} {\sum }_{j}^{N - 1} {K}_{j} ( {r}_{j} ) {K}_{i} ( {r}_{i} ) {Corr}_{ij} ,$$

where Kᵢ(rᵢ) is a monotonically increasing function ranging between zero and one that represents the amount of source node i that can be obtained at the resource cost rᵢ (e.g., a source node having one set price can be represented by a step function that was zero below the set price and one above the set price), and Cost (r₁, r₂, . . . rᵢ) is the aggregated costs of all of the resources. Corrᵢⱼ is a correlation function between source nodes i and j representing saturation wherein a subset of receiving node obtaining posts by both source nodes i and j are affected less (or more) by the combination of i and j's posts than the sum of the separate effects of i and j's posts. Minimizing the cost function will result in the optimal allocation of resources.

In a commercial setting, the resources/cost can be money spent on advertising and the benefit can be the increased revenue resulting from the social-media campaign. In a political setting, such as an election campaign, the cost may be the scarcity of personnel and/or money devoted to the social-media campaign. One of ordinary skill in the art will recognize that social media can be used for conveying many different messages and that social media can be used to pursue various political, commercial, academic, social, religious, and other public relations goals. The resources, costs, and benefits in the above cost-benefit equation can be used many different enterprises including commercial, social, academic, and political enterprises wherein scarcity requires trade-offs between resources including: money, goodwill, listener fatigue, political capital, etc.

In process 540, many different methods can be used to perform the global optimization of the cost-benefit function. In one implementation, a two-step process is used. The first step, which includes cumbersome and slowly converging global optimization, is used to locate the general region of the global minimum, and then linear optimization, which tends to converge more quickly, is used in a second step converge to the exact global minimum. When the cost-benefit function has local minima that are different from the global minimum, a robust stochastic optimization process is beneficial to find the global minimum of the cost-benefit function. There are many known methods for finding global minima including: genetic algorithms, simulated annealing, exhaustive searches, interval methods, and other conventional deterministic, stochastic, heuristic, and metatheuristic methods.

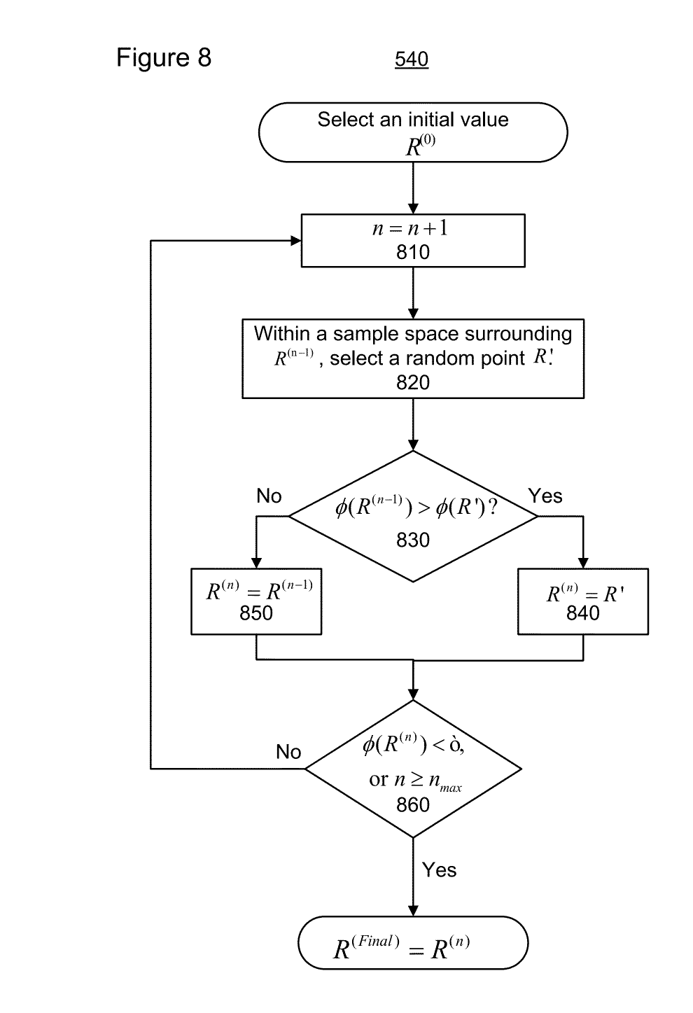

FIG. 8 shows one implementation of a global optimization method that can be used to perform the process 540. In FIG. 8, the process 540 starts when an initial value is selected R⁽⁰⁾=(r₁, r₂, . . . , r_{N}) from a predefined parameter space. The predefined parameters space can be constrained according to desired characteristics of the desired resource allocation. For example, only a limited amount of total resources may be available, making global minimum solution allocating resources exceeding the limited amount of total resources undesirable or unfeasible (e.g., there may be a limited number of people or there may be a finite budget). Thus, constrained optimization can be used to represent mathematically the real-world physical limitations on resources. Step 810 increments the loop variable n.

Following step 810, the process 540 proceeds to step 820, wherein a new sample point R′ is randomly selected from the sample space surrounding the current set of projection lengths R⁽ⁿ⁻¹⁾=(r₁⁽ⁿ⁻¹⁾, r₂⁽ⁿ⁻¹⁾, . . . , r_{N}⁽ⁿ⁻¹⁾).

Proceeding to step 830, the process 540 inquiries as to which of value of the cost-benefit function φ(R⁽ⁿ⁻¹⁾) or φ(R′) is smaller. In steps 840 and 850 the argument corresponding to the smaller value of the cost-benefit function is assigned as the next set of projection lengths R⁽ⁿ⁾=(r₁⁽ⁿ⁾, r₂⁽ⁿ⁾, . . . , r_{N}⁽ⁿ⁾) for the next loop iteration. Step 860 of process 540 evaluates whether the loop stopping criteria is satisfied.

Although different stopping criteria can used, FIG. 8 shows an implementation wherein the loop stops when either a maximum number of loop iterations nₘₐₓ has been reached or the cost-benefit function falls below a predetermined threshold E. If the stopping criteria are satisfied, the process 540 exits the loop at 860 and reports the current projection length R⁽ⁿ⁾=(r₁⁽ⁿ⁾, r₂⁽ⁿ⁾, . . . , r_{N}⁽ⁿ⁾) as the final projection length. Otherwise, the loop continues by proceeding from step 860 back to step 810.

In one implementation, the process 540 will be used initial with coarse searching criteria, and then the minimum found using coarse searching criteria will be refined using a second search with finer searching criteria. In one implementation, coarse search version of the implementation of process 540 shown in FIG. 8 can include that the stopping criterion threshold ε will be larger than it would be in a corresponding fine search, and the value of nₘₐₓ will be smaller than in a corresponding fine search.

In one implementation, a global minimum search using method 540 with coarse search criteria is used for an initial search to find the approximate neighborhood of a global minimum. Then, following a coarse global search, a fine search using fine search criteria is used to refine the rough approximation of the global minimum obtained using the coarse global search. The fine search uses the final value of the coarse search as its starting value of the fine search.

By using a coarse global search with search criteria sufficient to find a small enough neighborhood of the global minimum that also includes local minima that are not the global minima, the fine search succeeding the coarse search does not need to be robust to the global optimization problem (i.e., a local optimization method should be adequate for the second search). Therefore, the fine search can use a local minimum optimization method and does not need to use a global optimization method, which can converge more slowly than local optimization methods.

After finding the resource allocation optimizing the cost-benefit equation, the social-media campaign can be conducted over a series of time and the results of the social-media campaign can be monitored providing feedback and additional survey data to tune the influence curve and update the SCV model and the cost-benefit calculation. Thus, the allocation of resources can be corrected as the SCV model is better understood.

While certain implementations have been described, these implementations have been presented by way of example only, and are not intended to limit the teachings of this disclosure. Indeed, the novel methods, apparatuses and systems described herein may be embodied in a variety of other forms; furthermore, various omissions, substitutions and changes in the form of the methods, apparatuses and systems described herein may be made without departing from the spirit of this disclosure.

1. A method of valuing social capital in a social network, the method comprising:
categorizing, according to predefined criteria stored in memory of a processor, a plurality of receiving nodes in communication with a source node originating a post on an internet, wherein each receiving node that connects to the source node is categorized into one of a need category, a trust category, an admire category, and an opposition category;
calculating a total opposition value of the source node using a function including a number of the receiving nodes categorized into the opposition category, a number of the receiving nodes categorized into the need category, a number of the receiving nodes categorized into the trust category, and a number of the receiving nodes categorized into the admire category;
calculating a support value of the source node to include the difference between a number of receiving nodes connected to the source node and the total opposition value of the source node; and
transforming the support value into a social capital value (SCV) by calculating in the processor a ratio of the square of the support value and a weighted sum of the number of receiving nodes respectively categorized into the opposition category, the need category, the trust category, and the admire category.

2. The method according to claim 1, wherein
each receiving node of the plurality of receiving nodes is configured to receive the post on the internet originated by the source node; and
each receiving node of the plurality of receiving nodes is further configured to output on the internet a response message responding to the received post according to input of a user of the receiving node, wherein the response message can be any combination including at least one of no message, a “like” message, a “comment” message, and a “share” message.

3. The method according to claim 2, wherein each receiving node of the plurality of receiving nodes is categorized according to a number of the “like” messages, the “comment” messages, and the “share” messages of the receiving node responding to a plurality of posts of the source node.

4. The method according to claim 3, wherein the plurality of receiving nodes are categorized according to:
determining that each of the plurality of receiving nodes outputting a combination of “share” messages, “comment” messages, and “like” messages indicative of a common belief with the source node or indicative of blind trust in the source node is a member of the need category;
determining that each of the plurality of receiving nodes outputting a combination of “share” messages, “comment” messages, and “like” messages indicative of opposition to the source node and is not in the need category is in the opposition category;
determining that each of the plurality of receiving nodes outputting a combination of “share” messages, “comment” messages, and “like” messages indicative of conditional support and limited redistribution of posts of the source node and is not in either the need category or in the opposition category is in the trust category, and
determining that each of the plurality of receiving nodes that is not in the need category, in the trust category, or in the opposition category, is in the admire category.

5. The method according to claim 4, wherein the plurality of receiving nodes are categorized according to:
determining that each of the plurality of receiving nodes outputting a first combination of “share” messages, “comment” messages, and “like” messages exceeding a first threshold is a member of the need category;
determining that each of the plurality of receiving nodes outputting a second combination of “share” messages, “comment” messages, and “like” messages not exceeding a second threshold and is not in the need category is in the opposition category;
determining that each of the plurality of receiving nodes outputting a third combination of “share” messages, “like” messages, and “comment” messages exceeding a third threshold and is not in the need category or in the opposition category is in the trust category; and
determining that each of the plurality of receiving nodes that is not in the need category, in the trust category, or in the opposition category, is in the admire category.

6. The method according to claim 5, wherein the plurality of receiving nodes are categorized according to:
determining that each of the plurality of receiving nodes outputting a first linear combination of “share” messages, “comment” messages, and “like” messages exceeding the first threshold is a member of the need category;
determining that each of the plurality of receiving nodes outputting a second linear combination of “share” messages, “comment” messages, and “like” messages not exceeding the second threshold and is not in the need category is in the opposition category;
determining that each of the plurality of receiving nodes outputting a third linear combination of “share” messages, “like” messages, and “comment” messages exceeding the third threshold and is not in the need category or in the opposition category is in the trust category; and
determining that each of the plurality of receiving nodes that is not in the need category, in the trust category, or in the opposition category, is in the admire category.

7. The method according to claim 3, wherein the plurality of receiving nodes are categorized according to:
determining that each of the plurality of receiving nodes outputting a number of “share” messages exceeding a first threshold is a member of the need category
determining that each of the plurality of receiving nodes outputting a number of “share” messages not exceeding the first threshold and exceeding a second threshold, outputting a number of “like” messages exceeding a third threshold, and liking or commenting on more than a fourth threshold is in the trust category,
determining that each of the plurality of receiving nodes outputting a number of “share” messages not exceeding the second threshold, outputting a number of “like” messages not exceeding a fifth threshold, outputting a number of “comment” messages exceeding a sixth threshold, and is not in the need category or in the trust category, is in the opposition category; and
determining that each of the plurality of receiving nodes that is not in the need category, trust category, or opposition category, is in the admire category.

8. The method according to claim 3, wherein the SCV function is calculated according to
$$SCV = \frac{S \vert S \vert}{{c}_{3} N + {c}_{2} T + {c}_{1} A + {c}_{4} OP} ,$$
wherein
N is a number of receiving nodes in the need category,
V is a total number of receiving nodes,
T is a number of receiving nodes in the trust category,
A is a number of receiving nodes in the admire category,
S is a support function, and
c₁, c₂, c₃, and c₄ are the SCV coefficients and are tunable parameters.

9. The method according to claim 8, wherein the support function S is calculated according to
$$S = V - OP - OP \sqrt{{( \frac{N}{{w}_{3} V} )}^{2} + {( \frac{T}{{w}_{2} V} )}^{2} + {( \frac{A}{{w}_{1} V} )}^{2}} ,$$
wherein
w₁, w₂, and w₃ are the opposition weights, and are w₁, w₂, and w₃ are tunable parameters.

10. The method according to claim 3, further comprising:
determining an optimal allocation of resources to the source node to achieve a predetermined social-media effect by optimizing a cost-benefit function, wherein the cost-benefit function includes that a benefit value of the source node that is proportional to the SCV function of the source node.

11. The method according to claim 10, the step of determining the optimal allocation of resources is performed using a global optimization method to obtain a global minimum of the cost-benefit function.

12. The method according to claim 10, further comprising:
tuning the opposition weights and the SCV coefficients to minimize a predetermined distance measure between the SCV function and an influence function representative of effects of a post of the source node on the plurality of receiving nodes respectively categorized into the need category, the trust category, the admire category, and the opposition category.

13. The method according to claim 12, further comprising:
obtaining survey data indicative of an effect on the plurality receiving nodes due to the plurality of posts of the source node;
calculating an influence curve by calculating an average effect for each of a plurality of randomly selected subsets of the survey data; and
scaling the range of the influence curve to correspond to the range of the SCV function.

14. The method according to claim 10, wherein the predetermined distance measure between the influence function and the SCV function is a root-mean-square measure over a set of values for α, β, and Ω, wherein
α is a ratio between a number of receiving nodes in the need category N and a total number of receiving nodes V,
β is a ratio between a number of receiving nodes in the trust category T and a total number of receiving nodes V, and
Ω is a ratio between a number of receiving nodes in the admire category A and a total number of receiving nodes V.

15. A social capital value computational apparatus, comprising:
an interface connectable to the internet; and
processing circuitry connected to the interface and programmed to
categorize, according to predefined criteria stored in memory of a processor, a plurality of receiving nodes in communication with a source node originating a posting on the internet, wherein each receiving node that connects to the source node is categorized into one of a need category, a trust category, an admire category, and an opposition category,
calculate a total opposition value of the source node using a function including a number of the receiving nodes categorized into the opposition category, a number of the receiving nodes categorized into the need category, a number of the receiving nodes categorized into the trust category, and a number of the receiving nodes categorized into the admire category,
calculate a support value of the source node to include the difference between a number of receiving nodes connected to the source node and the total opposition value of the source node, and
transform the support value into a social capital value (SCV) by calculating in the processor a ratio of the square of the support value and a weighted sum of the number of receiving nodes respectively categorized into the opposition category, the need category, the trust category, and the admire category.

16. The social capital valuation apparatus according to claim 15, wherein the processing circuitry is further configured to
determine an optimal allocation of resources to the source node to achieve a predetermined social-media effect by optimizing a cost-benefit function, wherein the cost-benefit function includes that a benefit value of the source node that is proportional to the SCV function of the source node.

17. The social capital valuation apparatus according to claim 16, wherein the processing circuitry is further configured to
tune parameters of the SCV function to minimize a predetermined distance measure between the SCV function and an influence function representative of an effect of a post of the source node on the plurality of receiving nodes.

18. The social capital valuation apparatus according to claim 16, wherein the processing circuitry is further configured to
obtain survey data indicative of the effects on the plurality receiving nodes due to the plurality of posts by the source node;
calculate an influence curve by calculating an average effect for each of a plurality of randomly selected sub sets of the influence data; and
scale the range of the influence curve to correspond to the range of the SCV function.

19. The social capital valuation apparatus according to claim 16, wherein the processing circuitry is further configured to calculate the SCV function is calculated according to
$$SCV = \frac{S \vert S \vert}{{c}_{3} N + {c}_{2} T + {c}_{1} A + {c}_{4} OP} ,$$
wherein
N is a number of receiving nodes in the need category,
V is a total number of receiving nodes,
T is a number of receiving nodes in the trust category,
A is a number of receiving nodes in the admire category,
S is a pure support function, and
c₁, c₂, c₃, and c₄ are each one of the SCV coefficients that are tunable parameters.

20. A non-transitory computer-readable medium storing executable instructions, wherein the instructions, when executed by processing circuitry, cause the processing circuitry to perform the method according to claim 1.
